(19) United States
(12) Patent Application Publication
(10) Pub. No.: US 2023/0038327 A1
(43) Pub. Date: Feb. 9, 2023

(54) FLUID DISPOSING SYSTEM AND CENTRIFUGAL SEPARATION METHOD USING THE SAME

(71) Applicant: CYTODX INC., Daejeon (KR)

(72) Inventors: Joseph SUNOO, Seongnam-si (KR); Min Pyo Hong, Suwon-si (KR); Sin Uk Ryu, Seoul (KR)

(73) Assignee: CYTODX INC., Daejeon (KR)

(21) Appl. No.: 17/485,939

(22) Filed: Sep. 27, 2021

(30) Foreign Application Priority Data
Aug. 9, 2021 (KR) 10-2021-0104490

(51) Int. Cl. B04B 5/04; B04B 7/04; B04B 5/10; B04B 5/12; B04B 15/06

(52) U.S. Cl. CPC B04B 5/0442; B04B 7/04; B04B 5/10; B04B 5/12; B04B 15/06

(57) ABSTRACT

A fluid disposing system includes a centrifugal separator that centrifugally separates a liquid that is supplied, a reagent injecting apparatus coupled to the centrifugal separator and that injects a reagent into the centrifugal separator, a reagent supply module that supplies the reagent to the reagent injecting apparatus and a pipetting module provided on an upper side of the centrifugal separator and that feeds the fluid to the centrifugal separator.

### CROSS-REFERENCE TO RELATED APPLICATION(S)

This application is based on and claims priority under 35 U.S.C. § 119 to Korean Patent Application No. 10-2021-0104490, filed on Aug. 9, 2021, in the Korean Intellectual Property Office, the disclosure of which is incorporated by reference herein its entirety.

### BACKGROUND

### 1. Field

The disclosure relates to a fluid disposing system and a centrifugal separation method using the same, and more particularly, to a fluid disposing system including a centrifugal separator, and a centrifugal separation method using the same.

### 2. Description of Related Art

A centrifugal separator may be used to extract peripheral blood mononuclear cells (PBMCs) or circulating tumor cells (CTCs) from blood. However, because an extremely small number of PBMCs or CTCs are present in blood and the cells may die if they are not separated within 24 hours after the blood of a person is collected, it is necessary to promptly and accurately extract the cells.

However, according to the conventional technology, because a reagent, a magnet, and a separator are used to separate CTCs and the like and a person directly intervenes with the separation process, a deviation of the result cannot be avoided according to the ability of the person that intervenes with the separation process, and there is a limit in the repetitiveness and the precision of the separation process.

For example, according to the conventional technology, they are extracted by injecting a floating density gradient material and blood into a container such as a conical tube for centrifugal separation, and inserting an extraction unit such as a pipette to a portion, at which the separated PBMCs are located. However, because the PBMCs or the CTCs may be easily lost as the blood and the density gradient material injected before the centrifugal separation and there is a limit in manually accurately inserting the extraction unit into the portion, at which the PBMCs are located, it is difficult to quantitatively extract the PBMCs or the CTCs.

Furthermore, according to the conventional technology, to extract target cells of high purity, a secondary centrifugal separation may be performed by extracting only a specific material after a primary centrifugal separation. However, there is a limit in accurately and promptly performing a process of carrying the primarily centrifugally separation material to another centrifugal separator or another chamber of centrifugal separation, for the secondary centrifugal separation. Similarly, there is a limit in accurately and promptly performing a process of supplying a fluid such as an additional density gradient material from an outside by an operator for the secondary centrifugal separation after the primary centrifugal separation.

### PRIOR TECHNICAL DOCUMENTS

### Patent Documents

(Patent Document 1) KR10-2001001 B1

### SUMMARY

Aspects of the disclosure are to address at least the above-mentioned problems and/or disadvantages and to provide at least the advantages described below. Accordingly, an aspect of the disclosure is to remarkably improve a repetitiveness and a precision of a separation process by implementing a complete automation in a separation process using a separator.

In accordance with an aspect of the disclosure, a fluid disposing system includes a centrifugal separator that centrifugally separates a liquid that is supplied, a reagent injecting apparatus coupled to the centrifugal separator and that injects a reagent into the centrifugal separator, a reagent supply module that supplies the reagent to the reagent injecting apparatus, a pipetting module provided on an upper side of the centrifugal separator and that feeds the fluid to the centrifugal separator, and a feeding module coupled to one side of the pipetting module, and that moves the pipetting module in an X axis direction and a Y axis direction corresponding to a horizontal direction, and a Z axis direction that is perpendicular to the horizontal direction.

The centrifugal separator may include a rotor body rotated about a rotary shaft extending in an upward/downward direction, a first chamber coupled to one side of the rotor body and having a first space in an interior thereof, and a second chamber coupled to an opposite side of the rotor body and having a second space in an interior thereof, and a size of the first space and a size of the second space are different.

The reagent injecting apparatus may include a nozzle moving unit including a nozzle part that receives the reagent from the reagent supply module, and being movable between an inside and an outside of the centrifugal separator in the Z axis direction, a nozzle accommodating unit coupled to the rotor body, and that supplies the reagent from the nozzle part to the first chamber when the nozzle moving unit is seated, and a fixing unit fixed to the centrifugal separator while being coupled to the nozzle moving unit such that the nozzle moving unit is movable in the Z axis direction.

The fluid disposing system may further include a separation module including a magnetic bead for magnetically separating a material that has been primarily separated by the centrifugal separator.

The separation module may include a first tube rack provided on one side of the centrifugal separator and having a space, in which a tube is accommodated, and a second tube rack provided on one side of the centrifugal separator and having a space, in which a tube is accommodated, and the first tube rack and the second tube rack may face each other.

The fluid disposing system may further include a tip disposing unit provided on one side of the first tube rack and the second tube rack, the tip disposing unit may be separated from the centrifugal separator while the first tube rack and the second tube rack being interposed therebetween, the tip disposing unit may include a tip accommodating member having an interior space for accommodating a tip, and a tip ejector provided at an upper portion of the tip accommodating member.

The fluid disposing system may further include a tip rack provided on one side of the tip disposing unit and having a space for accommodating the tip, and the tip rack may be spaced apart from the first tube rack and the second tube rack while the tip disposing unit being interposed therebetween.

The pipetting module may include a gripper that grips a tube, a large-capacity pipette part coupled to a lower portion of the gripper, and a small-capacity pipette part provided on one side of the large-capacity pipette part, and the large-capacity pipette part and the small-capacity pipette part may be integrally movable in an upward/downward direction.

In accordance with another aspect of the disclosure, a centrifugal separation method using a fluid disposing system includes a primary centrifugal separation operation of, by a centrifugal separator including a rotor body rotated along a rotary shaft in an upward/downward direction, primarily centrifugally separating an initial fluid in a space formed in an interior of a first chamber coupled to one side of the rotor body, a primary separated fluid feeding operation of, by a pipetting module that feeds a fluid from the centrifugal separator and a feeding module that feeds the pipetting module in an X axis direction and a Y axis direction corresponding to a horizontal direction, and a Z axis direction that is perpendicular to the horizontal direction, feeding a primary separated fluid that has been primarily centrifugally separated from the initial fluid from the first space to a second space formed in an interior of a second chamber coupled to an opposite side of the rotor body, a docking operation of moving a nozzle moving unit including a nozzle part that receives a reagent from a reagent supply module downwards in the Z axis direction such that the nozzle moving unit is coupled to the rotor body to be seated in a nozzle accommodating unit communicated with the first space, a weight center aligning operation of locating centers of weight of the first chamber and the second chamber on the rotary shaft by supplying the reagent supplied from the nozzle part to the first space through the nozzle accommodating unit, and a secondary centrifugal separation operation of secondarily centrifugally separating the primarily separated fluid in the second space after the nozzle moving unit is moved upwards in the Z axis direction.

The centrifugal separation method may further include a high-purity separated fluid feeding operation of feeding a high-purity separated fluid that has been centrifugally separated by the primary separated fluid through the secondary centrifugal separation operation to a separation module including a magnetic bead for magnetic separation, through the pipetting module, and a washing operation of supplying a washing liquid supplied from the nozzle part to the first space and washing the first space after the docking operation is repeated.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a system of the disclosure;

FIG. 2 is a perspective view of a centrifugal separator of the disclosure;

FIG. 3 is a view illustrating an operational state of a reagent injecting apparatus of the disclosure;

FIG. 4 is a view illustrating an operational state of a reagent supply module of the disclosure;

FIG. 5 is a perspective view of a pipetting module of the disclosure;

FIG. 6 is a perspective view of a second tube rack of the disclosure; and

FIG. 7 is a perspective view of a magnetic block of the disclosure.

### DETAILED DESCRIPTION

Hereinafter, various embodiments of the disclosure will be described with reference to the accompanying drawings. It should be understood that the disclosure is not limited to specific embodiments and includes various modifications, equivalents, and/or alternatives of the embodiments of the disclosure. With regard to the description of drawings, similar components may be denoted by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware.

Terms used in this specification are used to describe specified embodiments of the disclosure and are not intended to limit the scope of the disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the disclosure. In some cases, even if terms are terms which are defined in the specification, they may not be interpreted to exclude embodiments of the disclosure.

The embodiments disclosed herein are provided to describe the technical contents or for understanding of the technical contents, and the scope of the disclosure is not limited thereto. Accordingly, the scope of the disclosure should be construed to include all changes or various embodiments based on the technical spirit of the disclosure.

Hereinafter, preferred embodiments of the disclosure will be described in detail. Prior to the description of the disclosure, it will be noted that the terms and wordings used in the specification and the claims should not be construed as general and lexical meanings, but should be construed as the meanings and concepts that agree with the technical spirits of the disclosure, based on the principle stating that the concepts of the terms may be properly defined by the inventor(s) to describe the disclosure in the best manner.

Therefore, because the examples described in the specification and the configurations illustrated in the drawings are merely for the preferred embodiments of the disclosure but cannot represent all the technical sprints of the disclosure, it should be understood that various equivalents and modifications that may replace them can be present.

Throughout the specification, when it is described that a part includes an element, it may mean that the part may further include second element without excluding the second element unless a specially contradictory description is made.

The objectives, the specific advantages, and new features of the disclosure described in the specification will become clear from the following description and the preferred embodiments associated with the accompanying drawings. Throughout the specification, it is noted that the same or like reference numerals denote the same or like components even though they are provided in different drawings. The terms, such as “one surface”, “an opposite surface”, “first”, and “second”, are used to distinguish one element from others, and the elements are not limited by the terms. Hereinafter, in the following description of the disclosure, a description of related known technologies that may make the essence of the disclosure unnecessarily unclear will be omitted.

Hereinafter, an embodiment of the disclosure will be described in detail with reference to the accompanying drawings, and the same reference numerals denote the same members.

Hereinafter, the disclosure will be described in detail.

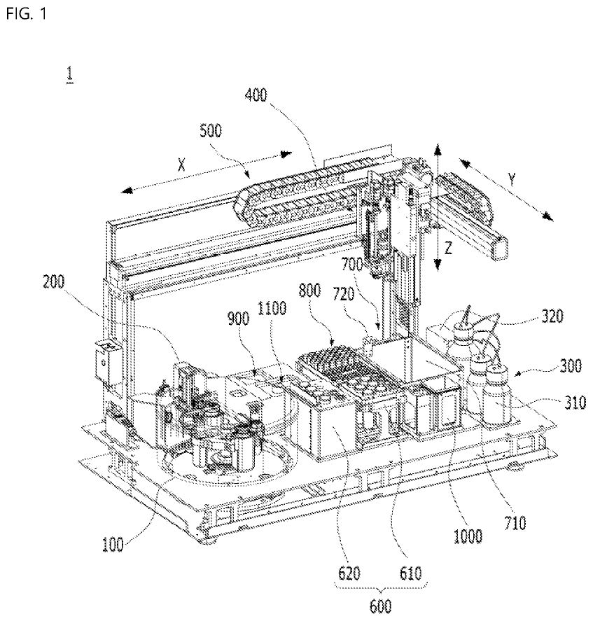

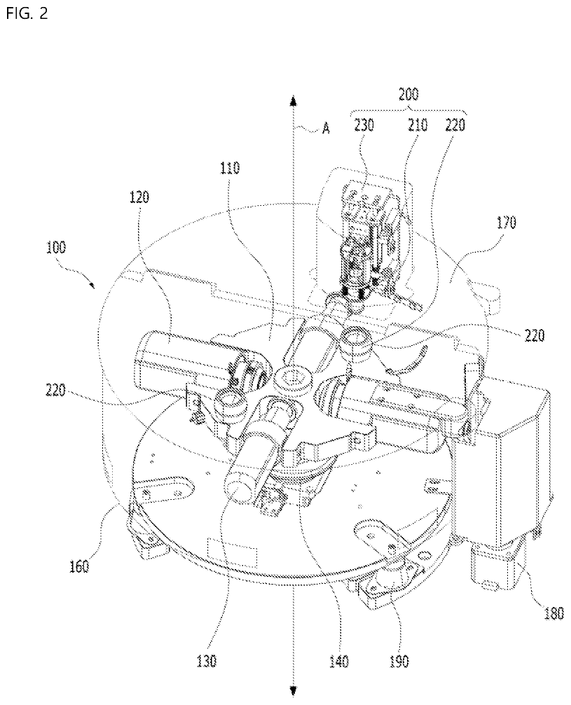

FIGS. 1 and 2 disclose views of a fluid disposing system 1 according to an embodiment of the disclosure.

The fluid disposing system 1 according to the embodiment of the disclosure includes a centrifugal separator 100 that centrifugally separates a liquid that is supplied, a reagent injecting apparatus 200 coupled to the centrifugal separator 100 and that injects a reagent into the centrifugal separator 100, a reagent supply module 300 that supplies the reagent to the reagent injecting apparatus 200, a pipetting module 400 provided on an upper side of the centrifugal separator 100 and that feeds the fluid to the centrifugal separator 100, and a feeding module 500 coupled to one side of the pipetting module 400, and that moves the pipetting module 400 in an X axis direction and a Y axis direction corresponding to a horizontal direction, and a Z axis direction that is perpendicular to the horizontal direction.

The fluid disposing system 1 according to the embodiment of the disclosure includes the centrifugal separator 100, the reagent injecting apparatus 200, the reagent supply module 300, the pipetting module 400, and the feeding module 500.

The centrifugal separator 100 is a configuration for centrifugally separating a fluid such as blood to separate a specific component of the blood, such as blood plasma or a peripheral blood mononuclear cell (PBMC).

The reagent injecting apparatus 200 is a configuration for automatically supplying the reagent to the centrifugal separator 100, and is coupled to the centrifugal separator 100. As an example, the above-described reagent may be a density gradient material or a washing liquid.

The reagent supply module 300 is a configuration for supplying the reagent to the reagent injecting apparatus 200, and may be spaced apart from the centrifugal separator 100. Furthermore, the reagent supply module 300 may include a reagent keeping member 310 for keeping the reagent, and a pump member 320 for supplying the reagent accommodated in the reagent keeping member 310 to an outside. The pump member 320 includes a first supply line 321 that supplies the reagent toward the reagent injecting apparatus 200.

Because the pipetting module 400 may be moved in a horizontal direction and a vertical direction by the feeding module 500, as will be described below, the pipetting module 400 may inject and discharge a fluid while moving the centrifugal separator 100 and the like and feeding a tube, in a process according to the fluid disposing system 1 according to the disclosure.

FIG. 2 illustrates a configuration of the centrifugal separator 100 and the reagent injecting apparatus 200 of the disclosure.

In the fluid disposing system 1 according to the embodiment of the disclosure, the centrifugal separator 100 may include a rotor body 110 rotated about a rotary shaft “A” extending in an upward/downward direction, a first chamber 120 coupled to one side of the rotor body 110 and having a first space in an interior thereof, and a second chamber 130 coupled to an opposite side of the rotor body 110 and having a second space in an interior thereof, and a size of the first space and a size of the second space may be different.

The centrifugal separator 100 may be a configuration of separating a component that is to be extracted from blood and the like in a centrifugal separation scheme.

In more detail, the centrifugal separator 100 may include the rotor body 110 rotated about a rotary shaft extending in an upward/downward direction, the first chamber 120 coupled to one side of the rotor body 110 and having a first space in an interior thereof, and the second chamber 130 coupled to an opposite side of the rotor body 110 and having a second space in an interior thereof, and may further include a motor 140. The rotor body 110 may be coupled to the motor 140 to be rotated about the rotary shaft extending in the vertical direction. The first chamber 120 and the second chamber 130 may be provided in a circumferential area of the rotor body 110. The first chamber 120 and the second chamber 130 may perform different functions. For example, while a primary centrifugal separation process is performed in the first chamber 120, a secondary centrifugal separation process is performed in the second chamber 130. Accordingly, according to the disclosure, two centrifugal separation processes having different processes may be performed in one centrifugal separator 100.

Furthermore, a plurality of first chambers 120 and a plurality of second chambers 130 may be provided. In the drawings, as an example, two first chambers 120 and two second chambers 130 may be provided, and the first chambers 120 and the second chambers 130 may be alternately provided along a circumference of the rotor body 110, and it is illustrated that the first chambers 120 and the second chambers 130 are disposed at an equal interval.

Meanwhile, according to the disclosure, a size of the first space formed by the first chamber 120 and a size of the second space formed by the second chamber 130 may be different. For example, the size of the first space may be larger than the size of the second space. Furthermore, according to the disclosure, the centrifugal separator 100 may further include a separate weight balancing member (not illustrated) such that an overall center of weight of structures that are rotated while the centrifugal separator 100 is operated by driving the motor 140 is located on the rotary shaft.

The centrifugal separator 100 may further include a rotary union that passes through a central area of the rotor body 110. The rotary union may include an inner race and an outer race, and may have a structure, in which the inner race and the outer race are rotated relative to each other. As an example, in the rotary union, the outer race and the rotor body 110 may be rotated but the inner race may be fixed when the motor 140 is operated. To achieve this, the outer race may be coupled to the rotor body 110.

Meanwhile, the rotary union may be a configuration that also functions to deliver the liquid to the first chamber 120 and the second chamber 130. Then, in the rotary union, a path for delivering the liquid to the chambers may have a single path. In this case, an overall configuration of the centrifugal separator 100 may become simple without being restricted by a limit in a rotational speed of the centrifugal separator 100.

Furthermore, the centrifugal separator 100 may further include a case 160 that accommodates the rotor body 110 and an upper portion of which is opened, an automatic door 170 coupled to an upper area of the case 160 and that opens and closes an interior space of the case 160, a vibration detecting unit 180 that detects vibration of the centrifugal separator 100 in a centrifugal separation process according to driving of the motor 140, and a damper 190 for reducing vibration generated by the centrifugal separator 100.

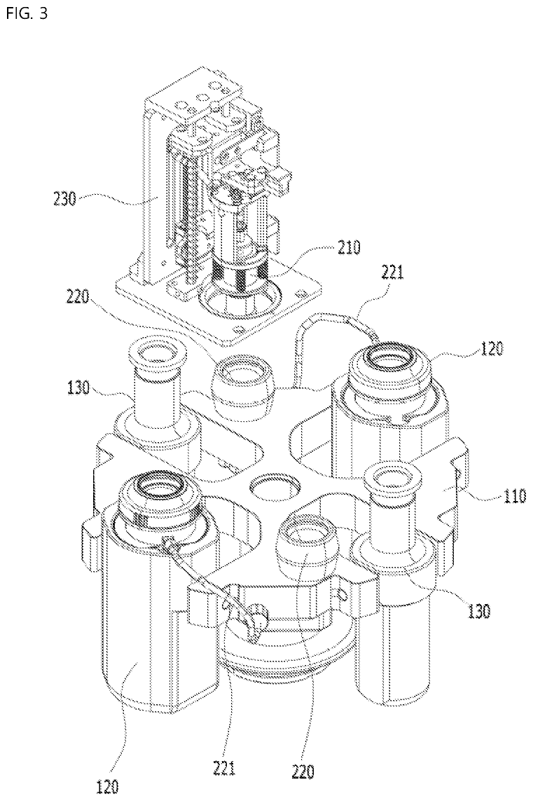

FIG. 3 illustrates a disposition relationship between the reagent injecting apparatus 200 and the centrifugal separator 100 according to the embodiment of the disclosure.

In the fluid disposing system 1 according to the embodiment of the disclosure, the reagent injecting apparatus 200 may include a nozzle moving unit 210 including a nozzle part 211 that receives the reagent from the reagent supply module 300, and that is movable between an inside and an outside of the centrifugal separator 100 in the Z axis direction, a nozzle accommodating unit 220 that is coupled to the rotor body 110 and supplies the reagent from the nozzle part 211 to the first chamber 120 when the nozzle moving unit 210 is seated, and a fixing unit 230 fixed to the centrifugal separator 100 while being coupled to the nozzle moving unit 210 such that the nozzle moving unit 210 is movable in the Z axis direction.

The reagent injecting apparatus 200 according to the embodiment of the disclosure may include the nozzle moving unit 210, the nozzle accommodating unit 220, and the fixing unit 230.

The nozzle moving unit 210 includes the nozzle part 211. The nozzle part 211 may receive the reagent through the first supply line 321 of the reagent supply module 300. Referring to FIG. 3, it may be seen that the nozzle moving unit 210 is disposed on the automatic door 170 of the centrifugal separator 100 to be moved in the Z axis direction. That is, the nozzle moving unit 210 may proceed toward the rotor body 110 when the rotor body 110 is stopped.

The nozzle accommodating unit 220 may be coupled to the rotor body 110. Furthermore, the nozzle accommodating unit 220 may have a shape, in which a nozzle moving unit 210 may be seated. Accordingly, the nozzle moving unit 210 receives the reagent from the nozzle part 211 and supplies the reagent to the first chamber 120 when being seated in the nozzle accommodating unit 220. The reagent may be moved between the nozzle accommodating unit 220 and the first chamber 120 through a second supply line 221.

The fixing unit 230 is coupled to the nozzle moving unit 210 such that the nozzle moving unit 210 is movable in the Z axis direction and is fixed to the centrifugal separator 100 as well. Accordingly, the nozzle moving unit 210 may be moved in the Z axis direction by the fixing unit 230. The fixing unit 230, as shown in FIG. 3, may be fixedly coupled to the automatic door 170.

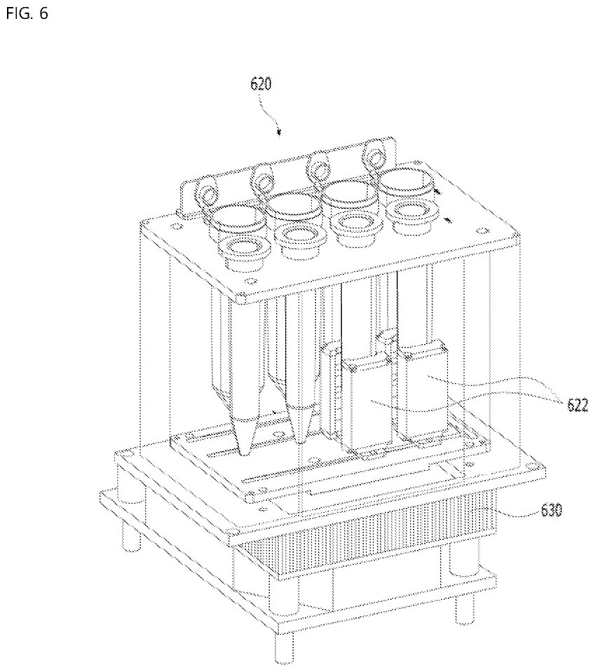

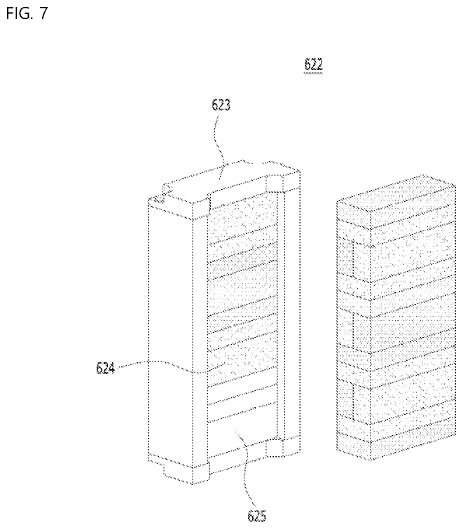

FIGS. 6 and 7 illustrate a separation module 600.

The fluid disposing system 1 according to the embodiment of the disclosure may include the separation module 600 including a magnetic bead for magnetically separating a material that has been primarily separated in the centrifugal separator 100.

In the fluid disposing system 1 according to the embodiment of the disclosure, the separation module 600 may include a first tube rack 610 that is provided on one side of the centrifugal separator and has a space, in which a tube is accommodated, and a second tube rack 620 that is provided on one side of the centrifugal separator and has a space, in which a tube is accommodated, and the first tube rack 610 and the second tube rack 620 may face each other.

The fluid disposing system 1 according to the embodiment of the disclosure may further include a tip disposing unit 700 that is provided on one side of the first tube rack 610 and the second tube rack 620, the tip disposing unit 700 may be separated from the centrifugal separator 100 while the first tube rack 610 and the second tube rack 620 being interposed therebetween, and the tip disposing unit 700 may include a tip accommodating member 710 having an interior space for accommodating a tip, and a tip ejector 720 provided at an upper portion of the tip accommodating member 710.

The fluid disposing system 1 according to the embodiment of the disclosure may further include a tip rack 800 that is provided on one side of the tip disposing unit 700 and has a space for accommodating the tip, and the tip rack 800 may be spaced apart from the first tube rack 610 and the second tube rack 620 while the tip disposing unit 700 being interposed therebetween.

The fluid disposing system 1 according to the embodiment of the disclosure may further include the separation module 600 including a magnetic bead for magnetically separating a material that has been primarily separated by the centrifugal separator.

Meanwhile, the separation module 600 may further include the first tube rack 610 that is provided on one side of the centrifugal separator and has a space, in which a tube is accommodated, and the second tube rack 620 that is provided on one side of the centrifugal separator 100 and has a space, in which a tube is accommodated. Then, the first tube rack 610 and the second tube rack 620 may face each other. The drawings illustrate as an example that the first tube rack 610 and the second tube rack 620 are provided on a right side of the centrifugal separator 100 to face the centrifugal separator 100 and the first tube rack 610 and the second tube rack 620 are provided in the Y axis direction.

For example, tubes for buffering for dilution of blood, extracting a specific material, such as a PBMC or plasma, and keeping the material in a concentrated state may be disposed in the first tube rack 610. Furthermore, although not illustrated in the drawings, the first tube rack 610 may further include an indexing apparatus for identifying a sample.

As will be described below, it may be preferable that a moving line, along which the sample is injected into the chamber or the tube provided in the centrifugal separator 100 and is fed by using the pipetting module 400 provided in the fluid disposing system 1 according to the disclosure, is minimized. Accordingly, as described above, it is more preferable that the first tube rack 610 and the second tube rack 620 are provided on one side of the centrifugal separator 100 to face the centrifugal separator 100.

Referring to the drawings continuously, the separation module 600 of the fluid disposing system 1 according to the disclosure may further include a Peltier element provided at a lower portion of the second tube rack 620, and the second tube rack 620 may further include a magnetic block 622 and a temperature measuring member (not illustrated).

In comparison with the first tube rack 610, the second tube rack 620 may be maintained in a low temperature state. For example, the second tube rack 620 may be maintained at a temperature of 3 degrees to 8 degrees Celsius.

To achieve this, a Peltier element 630 may be provided at a lower portion of the second tube rack 620. The Peltier element 630 may be a configuration capable of cooling one side by implementing a temperature difference between opposite ends by using a thermoelectric effect or a Peltier effect. That is, when an electric current flows in the Peltier element 630, a low temperature area of the Peltier element 630 may be configured to contact the second tube rack 620. Accordingly, the second tube rack 620 may be maintained in a low temperature state. For example, an outer case of the second tube rack 620 may be formed of a metallic material such as aluminum. In this case, heat of the second tube rack 620 may promptly flow to the Peltier element 630, and thus, the second tube rack 620 also may be promptly cooled. Meanwhile, an insulation member for interrupting heat transfer to an outside may be further included around an outer case of the second tube rack 620.

The magnetic block 622 may be a configuration for separating a magnetic bead coated with a specific antibody from a material that is to be extracted, in a process of extracting a material, such as a CTC. To achieve this, the magnetic block 622 may include an outer member 623, and a magnet member 624 provided in an interior of the outer member 623. The magnet member 624 provided in the magnetic block 622 may include an N pole area and an S pole area, and the N pole area and the S pole area may have a specific disposition structure that may have an optimum magnetic flux for separating the magnetic bead. Furthermore, the magnetic block 622 may further include a metal member 625 provided in a lower area of the magnet member 624 to correspond to a height of the tube, from which the magnetic bead is separated.

Referring to the drawings continuously, the fluid disposing system 1 according to the disclosure may further include the tip disposing unit 700 provided on one side of the first tube rack 610 and the second tube rack 620.

The tip disposing unit 700 may be a configuration of processing the tip used in a process of feeding, injecting, and discharging a material, such as a sample, by using the fluid disposing system 1 according to the disclosure.

Then, according to the disclosure, the tip disposing unit 700 may be spaced apart from the centrifugal separator 100 while the first tube rack 610 and the second tube rack 620 being interposed therebetween. The drawings illustrate that the tip disposing unit 700 is provided on a right side of the first tube rack 610 and the second tube rack 620 and is separated from the centrifugal separator 100 provided on a left side of the first tube rack 610 and the second tube rack 620.

Meanwhile, the tip disposing unit 700 may include the tip accommodating member 710 having an interior space for accommodating the tip, and the tip ejector 720 provided at an upper portion of the tip accommodating member 710. Accordingly, according to the disclosure, the used tip may drop into the interior space of the tip accommodating member 710 after being separated from the pipetting module 400 by the tip ejector 720.

Referring to the drawings continuously, the fluid disposing system 1 according to the disclosure may further include the tip rack 800 that is provided on one side of the tip disposing unit 700 and has a space, in which the tip may be accommodated.

The tip rack 800 is a configuration provided with the tip such that a new tip may be mounted on the pipetting module 400, and as an example, the tip rack 800 may be spaced apart from the first tube rack 610 and the second tube rack 620 while the tip disposing unit 700 being interposed therebetween. The drawings illustrate that the tip rack 800 is provided on a right side of the tip disposing unit 700 to be spaced apart from the first tube rack 610 and the second tube rack 620 provided on a left side of the tip disposing unit 700. In this case, because the used tip does not pass above the tip rack 800 provided with a tip that has not been used yet in a process of feeding the used tip from the centrifugal separator 100, the first tube rack, and the second tube rack to the tip disposing unit 700, the tip provided in the tip rack 800 may be prevented from being contaminated in advance.

However, unlike the illustration of the drawings, locations of the tip rack 800 and the tip disposing unit 700 may be exchanged. That is, unlike the illustration of the drawings, the tip disposing unit 700 may be provided on a right side of the tip rack 800 to be spaced apart from the first tube rack 610 and the second tube rack 620 provided on a left side of the tip rack 800.

Meanwhile, the fluid disposing system 1 according to the disclosure may further include a shaker 900 that is provided on one side of the second tube rack 620 and is provided adjacent to the second tube rack 620. The drawings illustrate that the shaker 900 is provided on one side of the second tube rack 620 in the Y axis direction to face the second tube rack 620. The shaker 900 may be a configuration for forming flows in a solution in the tube such that a material (for example, cells) in the solution accommodated in the tube of the second tube rack 620 is not deposited.

Referring to the drawings continuously, the fluid disposing system 1 according to the disclosure may further include a liquid disposing unit 1000 that is provided on one side of the tip disposing unit 700 or one side of the shaker 900 and is provided adjacent to the tip disposing unit 700 or the shaker 900. The drawings illustrate that the liquid disposing unit 1000 is provided on a right side of the shaker 900 and the liquid disposing unit 1000 faces the shaker 900. Furthermore, the drawings illustrate that the liquid disposing unit 1000 is provided on a lower side of the tip disposing unit 700 in the Y axis direction and is provided adjacent to the tip disposing unit 700. The liquid disposing unit 1000 may be a configuration for keeping a solution that is discarded after being used in a process of operating the fluid disposing system 1.

Referring to the drawings continuously, the fluid disposing system 1 according to the disclosure may further include a sorter unit 1100 provided on one side of the liquid disposing unit 1000. Then, the sorter unit 1100 may be spaced apart from the shaker 900 while the liquid disposing unit 1000 being interposed therebetween. The drawings illustrate that the sorter unit 1100 is provided on a right side of the liquid disposing unit 1000 and is spaced apart from the shaker 900 provided on a left side of the liquid disposing unit 1000. The sorter unit 1100, for example, may be a configuration of separating specific cells, such as CTCs, from blood and the like. In particular, the sorter unit 1100 may be a fluorescence activated cell sorter (FACS) for improving a purity of cells, such as CTCs, which are separated from the blood. The sorter unit 1100 may be spaced apart from the centrifugal separator 100, the first tube rack, and the second tube rack by a specific distance.

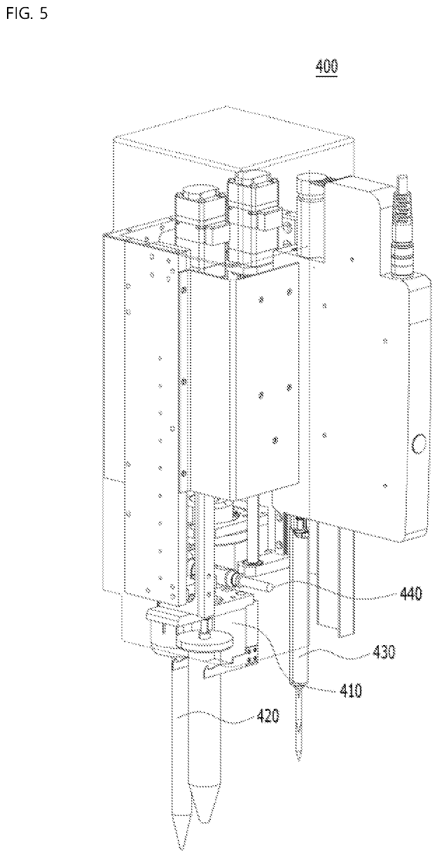

FIG. 5 illustrates the pipetting module 400 according to an embodiment of the disclosure.

In the fluid disposing system 1 according to the embodiment of the disclosure, the pipetting module 400 includes a gripper 410 configured to grip a tube, a large-capacity pipette part 420 coupled to a lower portion of the gripper 410, and a small-capacity pipette part 430 provided on one side of the large-capacity pipette part 420, and the large-capacity pipette part 420 and the small-capacity pipette part 430 may be integrally movable in an upward/downward direction.

Meanwhile, referring to the drawings continuously, the pipetting module 400 for feeding a fluid may include the gripper 410 configured to grip the tube, the large-capacity pipette part 420 coupled to the lower portion of the gripper 410, and the small-capacity pipette part 430 provided on one side of the large-capacity pipette part 420.

It is necessary to feed fluids or materials having various kinds of volumes in a fluid disposing process including the centrifugal separation process, and according to the disclosure, the large-capacity pipette part 420 and the small-capacity pipette part 430 are provided so that the fluids or the materials having various kinds of volumes may be smoothly fed.

In particular, according to the disclosure, the large-capacity pipette part 420 and the small-capacity pipette part 430 may be coupled to one shaft that may be moved in an upward/downward direction. That is, the large-capacity pipette part 420 and the small-capacity pipette part 430 may be integrally movable in the upward/downward direction. Accordingly, according to the disclosure, the large-capacity pipette part 420 and the small-capacity pipette part 430 may be simultaneously manipulated by moving the one shaft in the upward/downward direction.

Meanwhile, the gripper 410 may be a configuration for directly gripping the tube, and as illustrated in the drawings, may be provided adjacent the large-capacity pipette part 420. Meanwhile, the pipetting module 400 may further include an ultrasonic wave sensor 440 for detecting whether the tube is gripped by the gripper 410. The drawings illustrate that a distance sensor 440 is provided at an upper portion of the gripper 410.

The centrifugal separation method using the fluid disposing system 1 according to the embodiment of the disclosure includes a primary centrifugal separation operation of, by the centrifugal separator 100 including the rotor body 110 rotated along a rotary shaft “A” in an upward/downward direction, primarily centrifugally separating an initial fluid in a space formed in an interior of the first chamber 120 coupled to one side of the rotor body 110, a primary separated fluid feeding operation of, by the pipetting module 400 that feeds a fluid from the centrifugal separator 100 and the feeding module 500 that feeds the pipetting module 400 in an X axis direction and a Y axis direction corresponding to a horizontal direction, and a Z axis direction that is perpendicular to the horizontal direction, feeding a primary separated fluid that has been primarily centrifugally separated from the initial fluid from the first space to a second space formed in an interior of the second chamber 130 coupled to an opposite side of the rotor body 110, a docking operation of moving the nozzle moving unit 210 including the nozzle part 211 that receives a reagent from the reagent supply module 300 downwards in the Z axis direction such that the nozzle moving unit 210 is coupled to the rotor body 110 to be seated in the nozzle accommodating unit 220 communicated with the first space, a weight center aligning operation of locating centers of weight of the first chamber 120 and the second chamber 130 on the rotary shaft “A” by supplying the reagent supplied from the nozzle part 211 to the first space through the nozzle accommodating unit 220, and a secondary centrifugal separation operation of secondarily centrifugally separating the primarily separated fluid in the second space after the nozzle moving unit 210 is moved upwards in the Z axis direction.

The centrifugal separation method using the fluid disposing system 1 according to the disclosure is a method for separating a fluid by utilizing two times of centrifugal separations including the primary centrifugal separation operation and the secondary centrifugal separation operation.

The primary centrifugal separation operation is an operation of primarily centrifugally separating an initial fluid that may be blood or the like that is a target for separation in the first space of the first chamber 120.

In the primary separated fluid feeding operation, after the primary centrifugal separation operation, the primarily separated fluid separated from the initial fluid is fed to the second space of the second chamber 130. This is for secondarily centrifugally separating the primarily separated fluid in the second chamber 130. To feed the primarily separated fluid, the pipetting module 400 and the feeding module 500 may be utilized.

When the primarily separated fluid is feed from the first chamber 120 to the second chamber 130, a center of weight of the rotor body 110 and centers of weight of the coupled configurations that applies weights to the rotor body 110 are different. This is because the weight in the first chamber 120 is decreased and the weight in the second chamber 130 is increased. Accordingly, when the rotor body 110 is rotated, the reagent may be supplied to the second chamber 130 to align the overall center of weight with the rotary shaft “A”.

The docking operation is an operation of moving the nozzle moving unit 210 including the nozzle part 211 that supplies the reagent downwards in the Z axis direction and seating the nozzle moving unit 210 in the nozzle accommodating unit 220.

After the docking operation, in the weight center aligning operation, the centers of weight of the first and second chambers 120 and 130 are located on the rotary shaft “A” by supplying the reagent supplied from the nozzle part 211 to the first space of the first chamber 120 through the nozzle accommodating unit 220.

After the weight center aligning operation, after the nozzle moving unit 210 is moved upward in the Z axis direction, the secondary centrifugal separation operation of secondarily centrifugally separating the primarily separated fluid is performed.

The centrifugal separation method using the fluid disposing system 1 according to the embodiment of the disclosure may include a high-purity separated fluid feeding operation of feeding a high-purity separated fluid that has been centrifugally separated by the primary separated fluid through the secondary centrifugal separation operation to a separation module 600 including a magnetic bead for magnetic separation, through the pipetting module 400, and a washing operation of supplying a washing liquid supplied from the nozzle part 211 to the first space and washing the first space after the docking operation is repeated.

The centrifugal separation method using the fluid disposing system 1 of the disclosure may further include the high-purity separated fluid feeding operation and the washing operation.

The high-purity separated fluid separated through the primary and secondary centrifugal separation operation is fed to the separation module 600 to finally magnetically separate the high-purity separated fluid. Then, the pipetting module 400 and the feeding module 500 may be used to feed the high-purity separated fluid from the second chamber 130 to the separation module 600.

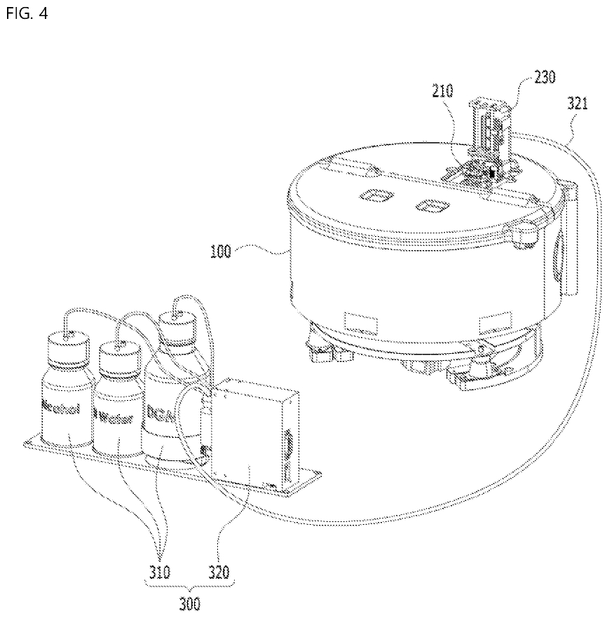

The washing operation is an operation for washing the first chamber 120, and the washing liquid is supplied to the first chamber 120 after the docking operation is repeated after the secondary centrifugal separation operation. Referring to FIG. 4, three reagent keeping members 310 are illustrated. That is, various reagents may be supplied to the nozzle part 211 through the plurality of reagent keeping members 310. Accordingly, a density gradient material may be injected into the first chamber 120 through the nozzle part 211 in the weight center aligning operation and a washing liquid may be injected into the first chamber 120 though the nozzle part 211 in the washing operation, but the disclosure is not limited thereto.

The fluid disposing system of the disclosure may remarkably improve a repetitiveness and a precision of a separation process by implementing a complete automation of a centrifugal separation process not by directly supplying a fluid by an operator but by supplying the fluid into a chamber of a centrifugal separator by a flud supply apparatus.

Furthermore, by using the fluid disposing system of the disclosure, a process of collecting and separating a specific component of blood, such as blood plasma or PBMCs by using a pipette and the like for a reagent treatment of the specific component may be omitted, and accordingly, the reagent treatment may be selectively made only on a specific layer while separated layers are maintained for the components in a chamber.

Until now, although the disclosure has been described in detail through the detailed embodiment, the embodiment is for describing the disclosure in detail, and the disclosure is not limited thereto but may be modified or improved by an ordinary person in the art, to which the disclosure pertains, without departing from the technical spirit of the disclosure.

Simple modifications or changes of the disclosure pertain to the areas of the disclosure, and thus the protection scope of the disclosure will become clearer by the attached claims.

What is claimed is:

1. A fluid disposing system comprising:
a centrifugal separator configured to centrifugally separate a fluid that is supplied;
a reagent injecting apparatus coupled to the centrifugal separator and configured to inject a reagent into the centrifugal separator;
a reagent supply module configured to supply the reagent to the reagent injecting apparatus;
a pipetting module provided on an upper side of the centrifugal separator and configured to feed the fluid to the centrifugal separator; and
a feeding module coupled to one side of the pipetting module, and configured to move the pipetting module in an X axis direction and a Y axis direction corresponding to a horizontal direction, and a Z axis direction that is perpendicular to the horizontal direction.

2. The fluid disposing system of claim 1, wherein the centrifugal separator includes:
a rotor body rotated about a rotary shaft extending in an upward/downward direction;
a first chamber coupled to one side of the rotor body and having a first space in an interior thereof; and
a second chamber coupled to an opposite side of the rotor body and having a second space in an interior thereof, and
wherein a size of the first space and a size of the second space are different from each other.

3. The fluid disposing system of claim 2, wherein the reagent injecting apparatus includes:
a nozzle moving unit including a nozzle part configured to receive the reagent from the reagent supply module, and being movable between an inside and an outside of the centrifugal separator in the Z axis direction;
a nozzle accommodating unit coupled to the rotor body, and configured to supply the reagent from the nozzle part to the first chamber when the nozzle moving unit is seated; and
a fixing unit fixed to the centrifugal separator while being coupled to the nozzle moving unit such that the nozzle moving unit is movable in the Z axis direction.

4. The fluid disposing system of claim 1, further comprising:
a separation module including a magnetic bead for magnetically separating a material that has been primarily separated by the centrifugal separator.

5. The fluid disposing system of claim 4, wherein the separation module includes:
a first tube rack provided on one side of the centrifugal separator and having a space, in which a tube is accommodated; and
a second tube rack provided on one side of the centrifugal separator and having a space, in which a tube is accommodated, and
wherein the first tube rack and the second tube rack face each other.

6. The fluid disposing system of claim 5, further comprising:
a tip disposing unit provided on one side of the first tube rack and the second tube rack,
wherein the tip disposing unit is separated from the centrifugal separator while the first tube rack and the second tube rack being interposed therebetween,
wherein the tip disposing unit includes:
a tip accommodating member having an interior space for accommodating a tip; and
a tip ejector provided at an upper portion of the tip accommodating member.

7. The fluid disposing system of claim 6, further comprising:
a tip rack provided on one side of the tip disposing unit and having a space for accommodating the tip,
wherein the tip rack is spaced apart from the first tube rack and the second tube rack while the tip disposing unit being interposed therebetween.

8. The fluid disposing system of claim 1, wherein the pipetting module includes:
a gripper configured to grip a tube;
a large-capacity pipette part coupled to a lower portion of the gripper; and
a small-capacity pipette part provided on one side of the large-capacity pipette part, and
wherein the large-capacity pipette part and the small-capacity pipette part are integrally movable in an upward/downward direction.

9. A centrifugal separation method using a fluid disposing system, comprising:
a primary centrifugal separation operation of, by a centrifugal separator including a rotor body rotated along a rotary shaft in an upward/downward direction, primarily centrifugally separating an initial fluid in a space formed in an interior of a first chamber coupled to one side of the rotor body;
a primary separated fluid feeding operation of, by a pipetting module configured to feed a fluid from the centrifugal separator and a feeding module configured to feed the pipetting module in an X axis direction and a Y axis direction corresponding to a horizontal direction, and a Z axis direction that is perpendicular to the horizontal direction, feeding a primary separated fluid that has been primarily centrifugally separated from the initial fluid from the first space to a second space formed in an interior of a second chamber coupled to an opposite side of the rotor body;
a docking operation of moving a nozzle moving unit including a nozzle part that receives a reagent from a reagent supply module downwards in the Z axis direction such that the nozzle moving unit is coupled to the rotor body to be seated in a nozzle accommodating unit communicated with the first space;
a weight center aligning operation of locating centers of weight of the first chamber and the second chamber on the rotary shaft by supplying the reagent supplied from the nozzle part to the first space through the nozzle accommodating unit; and
a secondary centrifugal separation operation of secondarily centrifugally separating the primarily separated fluid in the second space after the nozzle moving unit is moved upwards in the Z axis direction.

10. The centrifugal separation method of claim 9, further comprising:
a high-purity separated fluid feeding operation of feeding a high-purity separated fluid that has been centrifugally separated by the primary separated fluid through the secondary centrifugal separation operation to a separation module including a magnetic bead for magnetic separation, through the pipetting module; and
a washing operation of supplying a washing liquid supplied from the nozzle part to the first space and washing the first space after the docking operation is repeated.
